(19) United States
(12) Patent Application Publication
(10) Pub. No.: US 2002/0130927 A1
(43) Pub. Date: Sep. 19, 2002

(54) SUBSTRATE FOR USE OF INK JET HEAD, INK JET HEAD, AND INK JET APPARATUS

(76) Inventors: TOSHIMORI MIYAKOSHI, YOKOHAMA-SHI (JP); ICHIRO SAITO, YOKOHAMA-SHI (JP); YOSHIYUKI IMANAKA, KAWASAKI-SHI (JP); TERUO OZAKI, YOKOHAMA-SHI (JP); MUGA MOCHIZUKI, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/314,219

(22) Filed: May 19, 1999

(30) Foreign Application Priority Data
May 22, 1998 (JP) 10-141453

(51) Int. Cl. B41J 2/05

(52) U.S. Cl. 347/64

(57) ABSTRACT

A substrate for use of an ink jet head comprises a plurality of heat generating resistive elements formed on a substrate through insulation layer, electrode wiring electrically connected with said heat generating resistive elements, and protection layer to cover said heat generating resistive elements. Then, the protection layer of this substrate is made dielectric formed by plural atoms containing Si, and at the same time, the composition ratio of the dielectric of the portion of the protection layer at least nearest to the heat generating resistive elements is almost the stoichiometric composition ratio, and then, the composition ratio of the dielectric of the portion farthest from the heat generating resistive elements is richer in Si than the stoichiometric composition ratio. With the provision of this substrate, the heat conductivity becomes greater to make it possible to transfer heat generated by the heat generating resistive elements to ink side efficiently, while keeping the reliability of the film and the life thereof. Hence, it is made possible for an ink jet head provided with such substrate to reduce the power dissipation needed for bubbling without affecting the efficiency and the life of the head.

### BACKGROUND OF THE INVENTION

1. Field of the Invention

The present invention relates to a substrate for use of an ink jet head that records by discharging ink from the discharge ports by means of the development and contraction of bubbles in ink, which are effectuated by use of the discharge energy generating elements. The invention also relates to an ink jet head, and an ink jet apparatus as well.

2. Related Background Art

The ink jet recording method is capable of recording highly precise images in high density at high speeds. Not only this method makes it easier to form images in colors, but also, makes it easier to arrange the apparatus in a smaller size (as disclosed in the specifications of U.S. Pat. Nos. 4,723,129 and 4,740,796).

As shown in FIG. 1, the head used for the ink jet recording described above is provided with a plurality of discharge ports 1001. Also, each of the electro-thermal converting elements 1002 is arranged for each of the ink flow paths 1003 to generate the thermal energy to be utilized for discharging recording liquid (hereinafter referred as ink) from each of the discharge ports.

Each of the electrothermal converting elements 1002 comprises mainly the heat generating resistive element 1005, the electrode wiring 1006 to supply electricity to it, and the protection film 1007 to protect them.

Also, each of the ink flow paths 1003 is formed in such a manner that the ceiling plate, which is integrally formed with a plurality of flow path walls 1008, is bonded to the substrate 1004, while adjusting the relative positions with the electrothermal converting elements on the substrate and others by means of image processing or the like.

Each portion of the ink flow paths 1003 on the opposite end of the discharge port 1009 is communicated with the common liquid chamber 1009. To the common liquid chamber 1009, ink is supplied from an ink tank (not shown) and reserviored in it.

Ink, which is supplied to the common liquid chamber 1009, is led out from it to each of the ink flow paths 1003 and held by means of meniscus formed in the vicinity of each discharge port 1001.

At this juncture, the electrothermal converting elements 1002 are selectively driven to heat ink on the thermal activation surface abruptly to boil it by the utilization of thermal energy, hence discharging ink by the intensive force thus exerted.

Now, in order to protect the heat generating resistive elements from the use environment, there is provided a protection layer, each of them is in the severe environment where the thermal activation surface of the ink jet head is exposed to the mechanical shocks by a repetition of bubble generation and bubble disappearance of ink or exposed to the erosion, and also, exposed to the rises and falls of the temperature of almost 1,000° C. in a period of as extremely short as 0.1 to 10 usec, among some others.

The protection layer should be excellent in its resistance to heat, resistance to liquid, prevention of liquid permeability, stabilized oxidation, insulation, resistance to tearing damages, and heat conductivity. At present, SiO₂, SiN, or some other inorganic compounds are used in general.

Further, there are some cases where the single-layered protection layer is not good enough to present the sufficient protection capability for the heat generating resistive elements. Therefore, a metallic layer of Ta or the like is formed on the protection layer to provide a higher cavitation proof capability.

Also, besides the portion where the heat generating resistive elements are formed, the structure, such as described above, is arranged for the wiring pattern, for example, where the electrical connection is made with the heat generating resistive elements so as to protect the wiring from being eroded by the presence of ink.

In this manner, the heat generating substrate is formed with the thermal activation surface for use of an ink jet head. Here, the structure of the protection layer is one of the important factors to determine the performance of an ink jet head in terms of the power dissipation and the like, for example.

However, in accordance with the conventional structure of the protection layer, the requirement to lower the power dissipation conflicts inevitably with the assurance of the reliability of film and the life thereof.

For example, if only the heat generated by each of the heat generating resistive elements is made transferable to ink side efficiently, it should become possible to lower the power dissipation needed for bubbling. To this end, the thickness of the protection film on each heat generating resistive element should be made thinner or the material whose heat conductivity is greater may be used.

However, the inorganic compound, such as SiO₂ or SiN, which is currently used in general as the protection film for use of an ink jet head, does not present such a large conductivity as metal.

On the other hand, if the protection film is made thinner, there occurs a problem such as the creation of pin holes or the insufficient step coverage at the wiring steps. Then, ink may be allowed to enter to erode the electrode wiring and the heat generating resistive elements, hence lowering the reliability of ink discharges and the life thereof.

### SUMMARY OF THE INVENTION

It is an object of the present invention to provide an ink jet head capable of transferring heat generated by the heat generating resistive elements to ink side efficiently with the greater heat conductivity in terms of the total protection film without the presence of any problems discussed above, at the same time, reducing the power dissipation needed for bubbling, while securing the reliability of film and the life thereof.

The inventors hereof have directed attention to the fact that the heat conductivity of Si is almost 100 (W/mK) whereas that of the inorganic compound, such as SiO₂ or SiN, which is currently used in general as the protection film for use of an ink jet head, is approximately 1.4 (W/mK).

Then, in order to solve the problems discussed above, the inventors hereof have ardently studied and found that for the dielectric protection film formed by plural atoms containing Si, the dielectric composition ratio presents almost the stoichiometric composition ratio at least in the portion nearest to the heat generating resistive elements, and that this film also presents a structure in which the dielectric composition ratio is richer in Si in the portion farthest from the heat generating resistive elements than the stoichiometric composition ratio. As a result, the heat conductivity becomes greater in terms of the total protection film to make it possible to transfer heat generated by the heat generating resistive elements to ink side efficiently. It is also found that without making the thickness of the protection film thinner, that is, while keeping the reliability of the film and the life thereof, an ink jet head is made capable of reducing the power dissipation needed for bubbling. Thus, the inventors hereof have succeeded in completing the present invention based upon these findings.

Thus, it becomes possible to solve the problems discussed above, and to achieve the objectives of the invention by the provision of a substrate for use of an ink jet head which comprises a plurality of heat generating resistive elements for giving heat to ink formed on a substrate through insulation layer; electrode wiring electrically connected with said heat generating resistive elements; and protection layer to cover said heat generating resistive elements, and for this substrate, the protection layer is made dielectric formed by plural atoms containing Si, and the composition ratio of the dielectric of the portion of the protection layer at least nearest to the heat generating resistive elements is almost the stoichiometric composition ratio, and then, the composition ratio of the dielectric of the portion farthest from the heat generating resistive elements is richer in Si than the stoichiometric composition ratio.

Also, in order to achieve the objectives of the present invention, the ink jet head, which comprises a substrate for use of an ink jet head, is arranged to adopt the substrate referred to in the preceding paragraph, and at least the surface of such substrate is provided with insulating capability.

Further, the ink jet apparatus of the present invention is provided with the ink jet head referred to in the preceding paragraph, and also, provided with at least a member for mounting this head on it.

Other objectives and advantages besides those discussed above will be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention

### BRIEF DESCRIPTION OF THE DRAWINGS

FIG. 1 is a schematic plan view which shows the outline of one structural example of the substrate of the conventional ink jet head.

FIG. 2 is a schematic plan view which shows the substrate of an ink jet head in accordance with the embodiment of the present invention.

FIG. 3 is a cross-sectional view which shows the substrate schematically, taken along line III-III (cut vertically along one-dot chain line) in FIG. 2.

FIG. 4 is a schematic view which shows the outline of the recording apparatus which uses the ink jet head of the present invention.

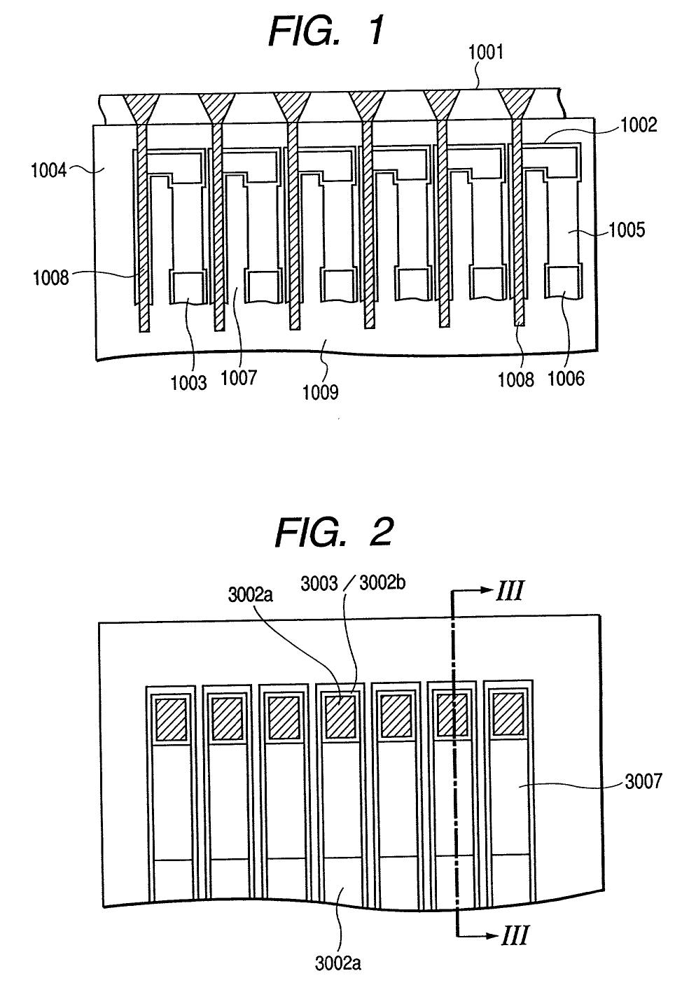

### DETAILED DESCRIPTION OF THE PREFERRED EMBODIMENTS

Hereinafter, in conjunction with the accompanying drawings, the details of the present invention will be described specifically in accordance with the embodiments thereof. However, the present invention is not necessarily limited only to the embodiments hereof. Various modifications of the disclosed embodiments, as well as other embodiments of the invention, will be applicable if only it is possible for any one of them to achieve the objectives of the present invention.

First Embodiment

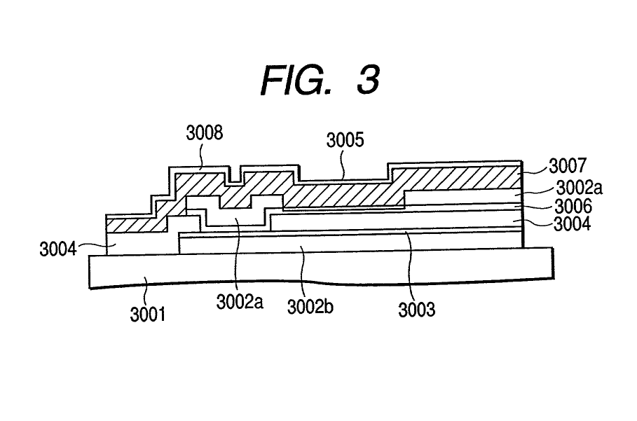

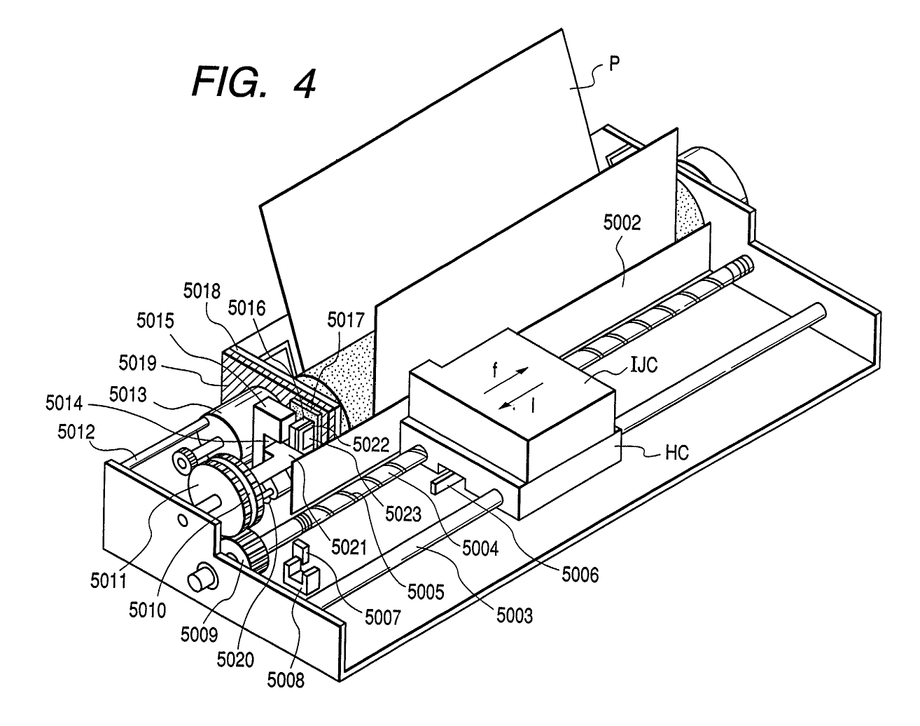

FIG. 2 is a schematic plan view which shows the substrate of the heat generating portion to bubble ink for the ink jet head in accordance with a first embodiment of the present invention. FIG. 3 is a cross-sectional view which schematically shows the section taken along line III-III (cut perpendicular to the surface of the substrate along one-dot chain line) in FIG. 2.

In accordance with the present embodiment, the substrate of the heat generating unit is produced by use of the Si substrate or the Si substrate on which the driving ICs have already been incorporated. For the Si substrate, the heat accumulation layer of SiO₂ is formed by the thermal oxidation method, the sputtering method, the CVD method, or the like. Likewise, for the Si substrate having the ICs already incorporated, the SiO₂ heat accumulation layer is formed in the manufacturing process thereof. In FIG. 3, a reference numeral 3001 designates such portion.

Then, by the sputtering method, the Al layer 3002b is formed in a thickness of 500 nm as the electrode wiring, and the TiW layer 3003 is formed in a thickness of 85 nm as the metal alloy layer that suppresses the influence exerted by the thermal stresses on the electrode wiring. Subsequently, using photolitho-graphic method the wiring pattern is formed by the reactive ion etching method to perform etching the TiW and Al continuously. After that, by the sputtering method, the CVD method, or the like, the interlayer insulation film 3004 is formed by SiN, SiO₂, or the like in a thickness of 1,400 nm.

Then, the TaN layer 3006 is formed in a thickness of 60 nm as the heat generating resistive elements, and the Al layer 3002a is formed in a thickness of 500 nm as the electrode wiring by the reactive sputtering and the sputtering, respectively. After that, using the photolithographic method, the wiring pattern is formed by the reactive ion etching method to continuously etch the Al and TaN in that order. Again, then, using the photolithographic method the Al is removed by the wet etching in order to allow the heat generating unit to be exposed as at 3005 in FIG. 3.

Now, by the sputtering method, the plasma CVD method, or the like, the silicon nitride dielectric film is formed in a thickness of 1,000 nm as the protection film 3007. At this juncture, the total flow amount and flow rate of the film formation gas are defined so that the silicon nitride or Si₃N₄ is obtained in an amount of 500 nm in the stoichiometric composition ratio in the initial state of the film formation. In this manner, the dielectric film is formed, and as the film formation advances, the introducing amount of reactive gas, such as ammonium, nitrogen, or oxygen, is gradually reduced to form the SiN dielectric layer having richer Si than that in the stoichiometric composition ratio.

Here, it may be possible to arrange the introducing amount of the reactive gas to become zero so that the layer is Si film for the one to be formed in the farthest side from the heat generating resistive elements. Also, as to the thickness of the dielectric film near the stoichiometric composition ratio, good insulation should be obtainable if it is at least 0.2 pm or more.

Then, as required, the Ta film 3008 is formed by patterning in a thickness of 230 nm as the cavitation proof and ink resistance film. In this manner, the ink jet substrate is produced.

Also, with the substrate described above, an ink jet head is produced to confirm the voltage (Vth) at which bubbling is initiated, and its discharging durability as well.

Table 1 shows the results thus confirmed.

First Comparative Example

When the dielectric film is formed with Si₃N₄ by the sputtering method, the plasma CVD method, or the like in a thickness of 1,000 nm as the protection film 3007, it is arranged to form the dielectric film uniformly in the thickness direction thereof. All other aspects are the same as those of the first embodiment. Then, the substrate for use of an ink jet head is produced.

Also, with the substrate described above, an ink jet head is produced in order to confirm the voltage (Vth) at which bubbling is initiated, and its discharging durability as well in the same manner as the first embodiment.

The Table 1 shows the results thus confirmed. In this respect, the Table 1 is prepared to compare the voltages (Vth) at which bubbling is initiated, and the discharging durabilities between the ink jet head using the substrate of the first embodiment for use thereof, and the ink jet head using the substrate of the first comparative example for use thereof.

TABLE 1

| | | Repeated Recording |
|---|---|---|
| | | of 3.0 × 10⁸ pulses |
| | | Driving voltage |
| | Bubble initiation | (Vop)/bubbling initiation |
| | voltage Vth (V) | voltage (Vth) = 1.3 |
| Embodiment 1 | 16.8 | Heat generating resistive |
| | | elements: No wiring |
| | | breakage |
| Comparative | 20.3 | Heat generating resistive |
| example 1 | | elements: No wiring |
| | | breakage |

Second Embodiment

FIG. 4 is a schematic view which shows the outer appearance of the ink jet apparatus to which the present invention is applicable. Interlocked with the regular and reverse rotations of the driving motor 5013, the lead screw 5004 rotates through the driving power transmission gears 5011 and 5009. The carriage HC is provided with a pin (not shown) which engages with the spiral groove 5005 formed on the lead screw to enable the carriage to reciprocate in the directions indicated by arrows.

A reference numeral 5002 designates the paper sheet pressure plate to press the paper sheet to the platen 5000 over the direction in which the carriage travels.

Reference numerals 5007 and 5008 designate means for detecting the home position, which are arranged by the photocoupler in order to recognize the presence of the lever 5006 of the carriage in this zone, hence switching the rotational directions of the motor 5013, among some other operations.

A reference numeral 5016 designates a member that supports the capping member 5022 to cap the entire surface of the recording head, and 5015, suction means for sucking the interior of the cap through the inner aperture 5023 in the cap to perform the suction recovery of the recording head.

A reference numeral 5017 designates a cleaning blade, and 5019, a member that enables this blade to move forward and backward, which is supported by the main body supporting plate 5018.

The blade is not necessarily limited to this mode. It is of course possible to adopt any type of known cleaning blade for the installation on the main body here.

Also, a reference numeral 5012 designates the lever which is arranged to initiate suction for the suction recovery, which is movable along the movement of the cam 5020 which engages with the carriage. The movement thereof is controlled by the driving power transmitted from the driving motor through known transmission means, such as switching the clutch or the like.

The structure is arranged so that each process of the capping, cleaning, suction recovery is performed as desired in the corresponding positions by the function of the lead screw 5004 when the carriage arrives in the home position. However, any structure may be applicable to this embodiment if only the desired operation is made executable at known timing.

The structure described above is excellent for use by its own or for use by the combination with some others complexly, which represents one of the preferred embodiments of the present invention.

Here, the apparatus described above is provided with means for supplying driving signals to drive the ink discharge pressure generating elements.

As described above, the ink jet head of the present invention makes it possible to increase the heat conductivity in terms of the total protection film formed on the substrate structured as described above. As a result, the heat generated by each of the heat generating resistive elements is transferred to ink side efficiently, hence obtaining an ink jet head which is capable of reducing the power dissipation needed for bubbling, while keeping the reliability and life of such film.

What is claimed is:

1. A substrate for use of an ink jet head comprising:
a plurality of heat generating resistive elements for giving heat to ink formed on a substrate through an insulation layer;
electrode wiring electrically connected with said heat generating resistive elements; and
a protection layer to cover said heat generating resistive elements, wherein
said protection layer is made dielectric formed by plural atoms containing Si, and the composition ratio of said dielectric of the portion of said protection layer at least nearest to said heat generating resistive elements is almost the stoichiometric composition ratio, and the composition ratio of said dielectric of the portion farthest from said heat generating resistive elements is richer in Si than the stoichiometric composition ratio.

2. A substrate for use of an ink jet head according to claim 1, wherein said dielectric contains at least either oxygen, nitrogen, or carbon.

3. A substrate for use of an ink jet head according to claim 1, wherein the film thickness of the portion of said dielectric having the composition ratio thereof being almost the stoichiometric composition ratio is 0.2 μm or more.

4. A substrate for use of an ink jet head according to claim 1, wherein the portion of the said dielectric having the composition ratio thereof being richer in Si than the stoichiometric composition ratio is made substantially Si film.

5. A substrate for use of an ink jet head according to claim 1, wherein said protection layer is formed by the sputtering method or the plasma CVD method, while the introducing amount of reactive gas being reduced gradually.

6. A substrate for use of an ink jet head according to claim 5, wherein said reactive gas contains at least either oxygen, nitrogen, or carbon.

7. An ink jet head comprising a substrate for use of an ink jet head, wherein
said substrate is the substrate for use of an ink jet head according to claim 1, and at least the surface of the substrate is provided with insulating capability.

8. An ink jet apparatus comprising an ink jet head, wherein
said ink jet head is the ink jet head according to claim 7, and said apparatus is provided with at least a member for mounting said head.
